(19) United States
(12) Patent Application Publication
(10) Pub. No.: US 2020/0005573 A1
(43) Pub. Date: Jan. 2, 2020

(54) Smart Door Lock System and Lock Control Method Thereof

(71) Applicant: Hangzhou Eyecloud Technologies Co., Ltd., Hangzhou (CN)

(72) Inventors: Po YUAN, San Jose, CA (US); Shengjun PAN, Pengzhou (CN); Junneng ZHAO, Hangzhou (CN); Daniel MARINIUC, Giroc, Timis (RO)

(21) Appl. No.: 16/238,489

(22) Filed: Jan. 2, 2019

Related U.S. Application Data
(63) Continuation-in-part of application No. 16/078,253.

(30) Foreign Application Priority Data
Jun. 29, 2018 (CN) PCT/CN2018/093697
Nov. 23, 2018 (CN) 201811402696.5

(51) Int. Cl. G07C 9/00; G06K 9/00; G06K 9/32; G06T 7/20

(52) U.S. Cl. CPC G07C 9/00563; G06K 9/00228; G06T 2207/20084; G06T 7/20; G06T 2207/30201; G06K 9/3241

(57) ABSTRACT

A smart door lock system provides an unlock authority of an electronically-controlled door lock mounted on a door to a remote computing device, thereby allowing the owner to remotely unlock the electronically-controlled door lock via the computing device rather than being physically present to perform the security check of the electronically-controlled door lock to open the door. Moreover, automatic transmission of the image data of the moving object in the field of view of a camera system in response to determining that one or more criteria are satisfied, facilitates door surveillance to help ensure personal and property's premise.

### CROSS REFERENCE OF RELATED APPLICATION

This is a Continuation-In-Part application that claims the benefit of priority under 35U.S.C. § 120 to a non-provisional application, application number U.S. Ser. No. 16/078,253 filed Date Aug. 21, 2018 which is a U.S. National Stage under 35 U.S.C. 371 of the International Application Number PCT/CN2018/093697 filed Date Jun. 29, 2018. This is also a non-provisional application that claims the benefit of priority under 35U.S.C. § 119 (A-D) to a Chinese patent application, application number 201811402696.5.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to door lock system, and more particular to a smart door lock system and lock control method thereof.

### Description of Related Arts

To help ensure personal and property's safety, access to a property's premise is typically controlled via a door locking mechanism (e.g., mechanical door lock, or electronically-controlled door lock) mounted on a door of the property's premise to control the opening and closing of the door. Conventional security door locks perform security checks when a person tries to unlock the door through methods such as passwords and fingerprints. For instance, an conventional electronically-controlled door lock may include an fingerprint recognition interface configured to receive entrance candidate fingerprint for selectively actuating the electronically-controlled door lock between a locked position and an unlocked position to control the opening and closing of the door thereby in response to receiving a candidate entrance fingerprint that matches an predefined unlock fingerprint.

In practical applications, conventional electronically-controlled door lock has encountered many drawbacks with these security checking methods. Firstly, without giving away the security information for security checks, a physical presence of the owner is required to successfully unlock the electronically-controlled door lock of the door. However, in many scenarios, it is desirable for the owner of the property's premise to remotely unlock the door for another family member or a visitor whom the owner thinks is safe and trustful enough to enter the property's premise.

Secondly, conventional electronically-controlled door locks do not have a monitoring system. That is, when burglars or other ill-intentioned people get a way to bypass the security check or break the door, the electronically-controlled door locks are unable to video record this situation for surveillance purpose and provide timely notification or alert for the owner. In order to mitigate this safety issue, additional surveillance camera system and/or alert systems must be purchased for monitoring the areas around the door. Commonly, such surveillance cameras are suspendedly and installed at a position proximate to the door, which not only requires additional wiring, but also the cameras themselves may easily get damaged since they are totally exposed (i.e. being stolen).

Consequently, there is an urgent desire for a smart door lock system with video surveillance functionality and user-friendly security check mechanism.

### SUMMARY OF THE PRESENT INVENTION

The invention is advantageous in that it provides a smart door lock system and door lock control method thereof, wherein the door lock system comprises an electronically-controlled door lock mounted on a door to control its opening and closing and a camera system and configured to capture image date for an moving object in the field of view thereof proximate to the door in response to an object motion detected in the field of view of the camera system. The image data of the moving object is then processed and analyzed with artificial intelligence algorithm to determine that one or more criteria are satisfied. Further, at least a portion of the image data of the moving object is outputted, in response to determining that one or more criteria are satisfied, for transmission to a remote computing device, such that the owner is allowed to unlock the electronically-controlled door lock by sending a unlock control command via the computing device remotely after determining that the moving object contained in the image data is safe or trustful enough to enter the purport's premise, and the area proximate to door is monitored via the camera system meanwhile.

According to one aspect of the present invention, it provides a smart door lock system, which comprises an electronically-controlled door lock, and a door lock controller, wherein the camera system comprises a motion detector configured to detect object motion in the field of view of the camera system, and a first camera device facing towards an outer side of the door, wherein the first camera is configured to capture image data of the moving object in the area outside the door in the field of view thereof in response to an object motion detected by the motion detector in the field of view of the camera system, wherein the door lock controller comprises at least one processor and one or more storage devices, the one or more storage device encoded with instructions that, when executed by the at least one processor, cause the at least one processor to: determine, by a door lock controller processing the image data of the moving object, that one or more criteria are satisfied, wherein the one or more criteria comprise determining that the objects contained in the image data includes human, or determining that the image data contains human face regions; output, in response to determining that one or more criteria are satisfied, at least a portion of image data of the moving object for transmission to a remote computing device; receive, by the door lock controller from the remote computing device, a unlock control command configured to cause the door lock controller to unlock an electronically-controlled door lock, wherein the electronically-controlled door lock is installed to control the opening and closing thereof between an opened position and locked position; and unlock, by the door lock controller in response to receiving the unlock control command from the remote computing device, the electronically-controlled door lock.

In one embodiment of the present invention, the camera system further comprises a second camera device opposed to the first camera device and facing towards an outer side thereof, wherein the second camera device is configured to capture image data of the moving object in the area inside the door in the field of view thereof.

In one embodiment of the present invention, the instructions that, when executed by the at least one processor, cause the door lock controller to: determine, by a door lock controller processing the image data of the moving object with a first deep neural network model, whether the objects contained in the image data includes human; determine, by the door lock controller processing the image data of the moving object with a second deep neural network model, that the image data contains human face regions; and In response to determining that the objects contained in the image data includes human, or determining that the image data contains human face regions, determine that one or more criteria are satisfied.

In one embodiment of the present invention, the first deep neural network model and the second deep neural network model have a same model architecture with different model parameters.

In one embodiment of the present invention, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of the present invention, instructions that, when executed by the at least one processor, cause the door lock controller to: identify different image regions between a first and a second image of the image data; group the different image regions between the first image and the second image into one or more regions of interest (ROIs); transform the one or more ROIs into grayscale; classify, by processing the grayscale ROIs with the first deep neural network model, the objects contained in the one or more ROIs; and determine whether the objects contained in the one or more ROIs includes human.

In one embodiment of the present invention, instructions that, when executed by the at least one processor, cause the door lock controller to: identify different image regions between a first and a second image of the image data; group the different image regions between the first image and the second image into one or more regions of interest (ROIs); transform the one or more ROIs into grayscale; and determine, by processing the grayscale ROIs with the second deep neural network model, whether the image data contains human face regions.

According to another aspect of the present invention, it further provides a smart door lock control method, comprising the following steps.

Detect an object motion in the field view of a camera system which comprises a first camera device positioned at a door and facing towards an outer side thereof, wherein the first camera is configured to capture image data of the moving object in the area outside the door in the field of view thereof.

Capture, by the first camera device of the camera system in response to detecting an object motion in the field view thereof, an image data of the moving object.

Determine, by a door lock controller processing the image data of the moving object, that one or more criteria are satisfied, wherein the one or more criteria comprise determining that the objects contained in the image data includes human, or determining that the image data contains human face regions.

Output, in response to determining that one or more criteria are satisfied, at least a portion of image data of the moving object for transmission to a remote computing device.

Receive, by the door lock controller from the remote computing device, a unlock control command configured to cause the door lock controller to unlock an electronically-controlled door lock, wherein the electronically-controlled door lock is installed on the door to control the opening and closing thereof between an opened position and locked position.

Unlock, by the door lock controller in response to receiving the unlock control command from the remote computing device, the electronically-controlled door lock.

In one embodiment of the present invention, the camera system further comprises a motion detector configured to detect object motion in the field of view of the camera system.

In one embodiment of the present invention, the camera system further comprises a second camera device opposed to the first camera device and facing towards an outer side thereof, wherein the second camera device is configured to capture image data of the moving object in the area inside the door in the field of view thereof.

In one embodiment of the present invention, the camera system is integrated in the electronically-controlled door lock.

In one embodiment of the present invention, wherein the step of determining, by a door lock controller processing the image data of the moving object, that one or more criteria are satisfied, comprises the following steps.

Determine, by a door lock controller processing the image data of the moving object with a first deep neural network model, whether the objects contained in the image data includes human.

Determine, by the door lock controller processing the image data of the moving object with a second deep neural network model, that the image data contains human face regions.

In response to determining that the objects contained in the image data includes human, or determining that the image data contains human face regions, determine that one or more criteria are satisfied.

In one embodiment of the present invention, the first deep neural network model and the second deep neural network model have a same model architecture with different model parameters.

In one embodiment of the present invention, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of the present invention, the step of determining, by a door lock controller processing the image data of the moving object with a first deep neural network model, whether the objects contained in the image data includes human, comprises the following steps.

Identify different image regions between a first and a second image of the image data.

Group the different image regions between the first image and the second image into one or more regions of interest (ROIs).

Transform the one or more ROIs into grayscale.

Classify, by processing the grayscale ROIs with the first deep neural network (DNN) model, the objects contained in the one or more ROIs.

Determine whether the objects contained in the one or more ROIs includes human.

In one embodiment of the present invention, the step of determining, by a door lock controller processing the image data of the moving object with a first deep neural network model, whether the objects contained in the image data includes human, comprises the following steps.

Identify different image regions between a first and a second image of the image data.

Group the different image regions between the first image and the second image into one or more regions of interest (ROIs).

Transform the one or more ROIs into grayscale.

Determine, by processing the grayscale ROIs with the second deep neural network (DNN) model, whether the image data contains human face regions.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a smart door lock system according to a preferred embodiment of the present invention.

FIG. 2 is a schematic diagram of the smart door lock system according to a modification mode of the preferred embodiment.

FIG. 3 is a flow diagram illustrating the process of determining whether the objects contained in the image data includes human by a door lock controller processing the image data of the moving object with a first deep neural network model.

FIG. 4 is a flow diagram illustrating the process of determining whether the image data contains human face regions, by the door lock controller processing the image data of the moving object with a second deep neural network model.

FIG. 5 is a flow diagram of a smart door lock control method according to the above preferred embodiment of the present invention.

### DETAILED DESCRIPTION OF THE PREFERRED EMBODIMENT

According to techniques of this disclosure, it provides a smart door lock system configured to control the opening and closing of a door of a property's premise. Accordingly, the door lock system comprises an electronically-controlled door lock and a camera system, wherein the camera system is configured to capture image data (e.g., video data, still image data, or other type of image data) of the moving object in the area proximate to the door in the field of view thereof. The image data of the moving object captured by the camera system is outputted, in response to determining that one or more criteria are satisfied, for transmission to a remote computing device. The owner of the property's premise can review the received image data of the moving object to determine whether to provide a unlock control command to unlock the locking mechanism of the door of the property's premise. In this way, the smart door lock system provides an unlock authority to a computing device which is remote from the door, thereby allowing the owner to remotely unlock the electronically-controlled door lock via the computing device rather than being physically present to perform the security check of the electronically-controlled door lock to open the door. Moreover, automatic transmission of the image data of the moving object, in response to determining that one or more criteria are satisfied, facilitates door surveillance through the integrated camera system to help ensure personal and property's safety.

In this disclosure, the one or more criteria include the objects contained in the image data including human and the image data containing human face regions. It is appreciated that the people detection and face detection are performed with artificial intelligence algorithm using specific deep neural network (DNN) models which are able to achieve a good trade-off between computational cost and detection precision. Further, the DNN model adopted in this disclosure has a relatively smaller model size that can be employed in a programmable terminal chip for processing the image data of the moving object to determine that one or more criteria are satisfied so as to facilitate the application of DNN model in terminal products.

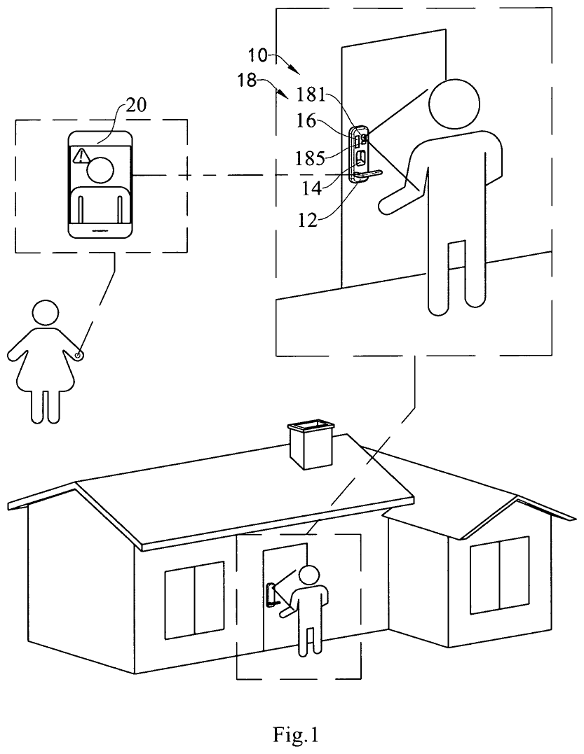

FIG. 1 is a schematic diagram illustrating one preferred embodiment of the smart door lock system 10 that can be used to control the actuation of an electronically-controlled door lock 12 of a property's premise. As illustrated in FIG. 1, the door lock system 10 can comprise an electronically-controlled door lock 12, a door lock control interface 14, a door lock controller 16, a camera system 18 and a computing device 20, wherein the electronically-controlled door lock 12 is mounted on a door of a property's premise and can be actuated between a locked and unlocked position to control the opening and closing of the door.

As illustrated in FIG. 1, the door lock controller 16 can be positioned proximate to the electronically-controlled door lock 12 (e.g, on a side of the electronically-controlled door lock 12, on a side of the door, on the electronically-controlled door lock 12 or other positions that proximate to the electronically-controlled door lock 12) to implement a security check mechanism of the electronically-controlled door lock 12 that when the security check mechanism is satisfied, the electronically-controlled door lock 12 is actuated to its unlock position to open the door. For instance the door lock control interface 14 can include a keypad (e.g., a numeric keypad, an alphanumeric keypad, or another keypad interface) configured to receive an entrance code (e.g., from the owner) for selectively actuating the electronically-controlled door lock 12 between a locked position and a unlocked position in response to receiving a candidate entrance code that matches an unlock code. In certain examples, the door lock control interface 14 can include a voice-recognition, fingerprint recognition, retinal scan recognition, facial recognition or other biometric interface to implement the security check mechanism of the electronically-controlled door lock 12 for selectively controlling activation of the electronically-controlled door lock 12.

The camera system 18 in this disclosure is integratedly installed in the and configured to capture image data of an area near the door in the field of view thereof. For instance, as in the example of FIG. 1, the camera system 18 is embedded in the electronically-controlled door lock 12 with its optical lens exposed to the external for capturing the image data in the field of view thereof. In this way, the camera system 18 integrated in the electronically-controlled door lock 12 can be considered as a door video monitoring system (DVMS) for monitoring the area proximate to the door especially the area proximate to the electronically-controlled door lock 12. It worth mentioning that since the camera system 18 is integrated in the electronically-controlled door lock 12, no extra wiring is required any longer for installing an additional camera device for outdoor and indoor surveillance as mentioned before, so that the integrity of the door area can be maintained for aesthetic purpose. Moreover, the camera system 18 integrated in the electronically-controlled door lock 12 is well-protected in the electronically-controlled door lock 12 (as an external protective casing for the camera system 18) from being damaged, so that the life span of the camera system 18 can be substantially expanded.

The camera system 18 in this disclosure can include a motion detector 185 and one or more camera devices, wherein the motion detector 185 is configured to detect an object motion in the field of view of the one or more camera device, and the one or more camera device are configured to capture (e.g., sense) image data (e.g., video and/or still image data) of the moving object in the area proximate to the door in the field of view thereof in response to detecting an object motion by the motion detector 185. In other words, the motion detection result generated from the motion detector 185 in this disclosure is configured as a control signal to activate the one or more camera device to capture image data of the moving object in the area proximate to the door in the field of view thereof in response to object motion being detected. As such, the camera system 18 in this disclosure can be considered to have two operation modes, standby mode and operation mode. In the standby mode, only the motion detector 185 of the camera system 18 is activated to detect object motion in the field of view of the camera system 18, and the camera system 18 is switched to its operation mode in response to an object motion being detected in the field of view of the camera system 18, that the one or more camera device are activated to capture image data of the moving object in the area proximate to the door in the field of view thereof. In this way, the power consumption of the camera system 18 can be substantially reduced.

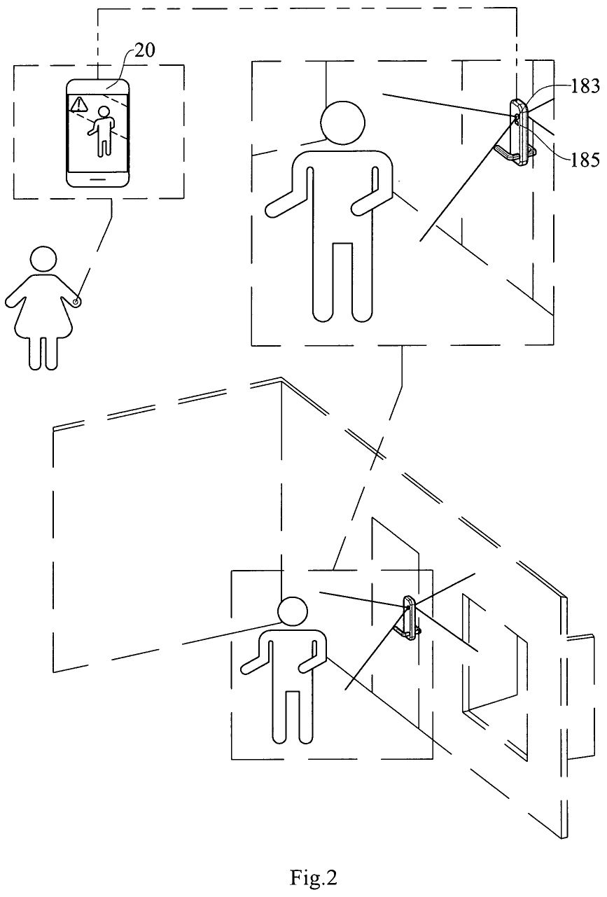

As illustrated in FIG. 1, the one or more camera device comprises a first camera device 181 installed in the electronically-controlled door lock 12 and facing towards an outer side of the door, wherein the first camera device 181 includes a first field of view of an area outside the door, such as an area extending from the door to within five feet, ten feet, or other distances from the door. Accordingly, when an object motion is detected in the field of view of the first camera device 181, the first camera device 181 is activated to capture the image data of the moving object in the area outside the door in the field of view thereof. In this way, the first camera device 181 can be considered as an outdoor video surveillance device to monitor the area proximate to the electronically-controlled door lock 12 outside the door to enhance the safety for the property's premise. FIG. 2 is a schematic diagram of the smart door lock system 10 according to a modification mode of the preferred embodiment. As illustrated in the FIG. 2, the one or more camera device further comprises a second camera device 183 integrated in the electronically-controlled door lock 12 and facing towards an inner side of the door, wherein the second camera device 183 includes a second field of view of an area inside the door, such as an area extending from the door to within five feet, ten feet, or other distances from the door. That is, the one or more camera device further comprise a second camera device 183 opposed with the first camera device 181 for indoor video surveillance in this modification mode. Accordingly, when an object motion is detected in the field of view of the second camera device 183, the second camera device 183 is activated to capture the image data of the moving object in the area inside the door in the field of view thereof. In this way, the second camera device 183 can be considered as an indoor video surveillance device to monitor the area proximate to the electronically-controlled door lock 12 inside the door to enhance the safety for the property's premise. In other words, the smart door lock system 10 in this disclosure may include two integrated camera devices (e.g., the first camera device 181 and the second camera device 183) with one camera device facing towards an inner side of the door activated by indoor motions for monitoring indoor area of the property's premise, while the other camera device facing towards an outer side of the door activated by outdoor motions for monitoring outdoor area of the property's premise.

It is important to mention that while illustrated in the example of FIG. 1 and FIG. 2 as including one or two camera device, in other examples, the one or more camera device can include more than two camera devices. For instance, the camera system 18 can further include a third camera device which is embedded in the electronically-controlled door lock 12 at a position lower or higher than the first camera device 181, wherein the third camera device faces towards an outer side of the door with a thud field of view different from the first field of view of the first camera device 181 so as to maximize the overall field of view of the camera system 18.

Camera devices (the first camera device 181, the second camera device 183 or the third camera device) in this disclosure can be and/or include any image capturing sensor and/or device configured to capture (e.g., sense) image data (e.g., video and/or still image data) in digital and/or analog form in response to an object motion being detected in the field of view of the camera system 18. Any one or more camera devices can store a threshold amount of image data within a data buffer, such as a circular (or ring) buffer that stores a threshold amount of image data corresponding to a threshold time period, such as a thirty seconds, five minutes, or other threshold time periods. In certain examples, the data buffer can be stored at computer-readable memory of the door lock controller 16. In this disclosure, the door lock controller 16 can include one or more processors and one or more storage device encoded with instructions that, when executed by the one or more processor, cause the door lock controller 16 to implement functionality of a smart door control method according to the techniques described below. For instance, the door lock controller 16 can be a terminal processing device positioned with the electronically-controlled door lock 12 and electronically and/or communicatively coupled with the camera system 18 for receiving the image data therefrom and a computing device 20 which is remote from the door to output image data of the moving object received from the camera system 18 for transmission to the remote computing device 20 in response to determining that one or more criteria are satisfied, as is further described below.

Examples of the one or more processors of the door lock controller 16 can include any one or more of a microprocessor, a controller, a digital signal processor (DSP), an application specific integrated circuit (ASIC), a field-programmable gate array (FPGA), or other equivalent discrete or integrated logic circuitry. Examples of one or more storage device can include a non-transitory medium. The term “non-transitory” can indicate that the storage medium is not embodied in a carrier wave or a propagated signal. In certain examples, a non-transitory storage medium can store data that can, over time, change (e.g. in RAM or cache). In some examples, the storage devices are a temporary memory, meaning that a primary purpose of the storage devices is not long-term storage. The storage devices, in some examples, are described as a volatile memory, meaning that the storage devices do not maintain stored contents when power to communication and lock switching controller is turned off. Examples of volatile memories can include random access memories (RAM), dynamic random access memories (DRAM), static random access memories (SRAM), and other forms of volatile memories. In some examples, the storage devices are used to store program instructions for execution by the one or more processors of door lock controller 16. The storage devices, in certain examples, are used by software applications running on door lock controller 16 to temporarily store information during program execution.

In operation, the image data of the moving object recorded by the camera system 18 is processed by the door lock controller 16 using specific algorithm to determine that one or more criteria are satisfied. Example one or more criteria can include the objects contained in the image data including human and the image data containing human face regions. In other words, the door lock controller 16 in this disclosure is adapted to implement people detection and face detection in the image data. Further, as one example of operation, if no criteria is satisfied in the image data, no further action will the door lock controller 16 perform and the camera system 18 returns back to its standby mode that only the motion detector 185 is activated to detect object motion in the field of view of the camera system 18. Instead, the door lock controller 16 outputs at least a portion of the image data (e.g., video image data, still image data, or other types of image data) captured by the camera system 18 for transmission via a wireless communication network to the computing device 20 which is remote from the door and communicatively coupled to the door lock controller 16 to receive the transmitted image data. In certain examples, the transmitted image data can include buffered data, such as buffered video data, a starting time of the buffered video data corresponding to a threshold time period prior to determining that the one or more alert criteria are satisfied, such as a threshold time period of thirty seconds, one minute five minutes, thirty minutes, or other threshold time periods.

Examples of remote computing device 20 include but not limited to desktop computers, laptop computers, tablet computers, mobile phones (including smart phone), personal digital assistants, or other computing device 20. Example wireless communication network can include, e.g., e.g., any one or more of a satellite communications (SATCOM) network, a cellular communications network, a wireless intemet (e.g., WiFi) communications network, a radio frequency (RF) communications network, or other types of wireless communication networks. In general, wireless communication network can be any wireless communication network that enables door lock controller 16 to send and receive data with a remote computing device 20, such as the remote computing device 20.

Further, the owner can view the image data received by the remote computing device 20 to evaluate the objects contained in the image data and to determine to transmit an unlock control command to the door lock controller 16, when the owner thinks the objects contained in the image data are warranted. The unlock control command is configured to cause the door lock controller 16 to actuate the electronically-controlled door lock 12 to its unlocked position to open the door. Accordingly, the door lock controller 16 unlocks the electronically-controlled door lock 12 in response to receiving the unlock control command from the remote computing device 20. In this way, the smart door lock system 10 provides an unlock authority to a computing device 20 which is remote from the door, thereby allowing the owner to remotely unlock the electronically-controlled door lock 12 via the computing device 20 rather than being physically present to perform the security check of the electronically-controlled door lock 12 to open the door.

On the contrary, if the objects displayed on the remote computing device 20 is possibly dangerous, the owner could refuse to provide the unlock control command. Further, the owner could further send a notification message or alert information to the door lock control which would broad this message to notify the possibly dangerous person via the remote computing device 20.

As mentioned above, the image data of the moving object collected by the camera system 18 is processed by the door lock controller 16 using specific algorithm to determine that one or more criteria are satisfied, wherein the one or more criteria comprises the objects contained in the image data including human and the image data containing human face regions. In this disclosure, the specific algorithm adopted for processing the image data for people detection and face detection is based on artificial intelligence.

More specifically, the door lock controller 16 could utilize the motion-based object detection method as disclosed in application U.S. Ser. No. 16/078,253 to process the image data to determine whether the objects contained in the image data includes human.

Accordingly, the motion-based object detection method comprises the following steps. First, a first and a second image of the image data are processed to extract one or more regions of the interest (ROIs) therefrom. The region of interest (ROI) refers to an image segment which contains a candidate object of interest in image processing technology. Since the object contained in the image data to be processed is moving object, the ROIs may be obtained by indentifying the moving parts in the images collected by camera system 18 of the door lock system 10. For purposes of clarity and ease of discussion, such ROI extraction method is defined as motion-based ROI extraction method.

From the perspective of image representation, the moving parts are the image segments having different image contents between images. Therefore, at least two images (a first image and a second image) are required in order to identify the moving parts in the images by a comparison between the first image and the second image. In other words, the image data to be processed in the door lock controller 16 comprises at least two image frames (e.g., the first image and the second image). Accordingly, the first and second images of the image data are captured by the camera system 18 (more particular, by the first camera device 181 or the second camera device 183) with a same background (the door area). This is the differences between the first image and the second image indicates the moving objects in the image data. Thus, the one or more ROIs can be formed by clustering the moving parts of the image data into larger ROIs. In other words, image segments with different image content between the first image and the second image are grouped to form the larger ROIs.

It worth motioning that the two image frames may be captured by the camera system 18 at a predetermined time interval, such as 0.5 s. It is appreciated that the time interval between the two image frames of the image data can be set at any value in this disclosure. For example, the first and the second images may be picked up from a video data (with a predetermined time window, such as 15 s) collected by the camera system 18. More particularly, the first and the second images could be two consecutive frames in the video data. In other words, the time interval of the first and the second image may be set as the frame rate of the video data.

It is important to mention that when capturing the image data by the camera system 18 (either the first camera device 181 or the second camera device 183), an unwanted movement (such as translation, rotation and scaling) may occur to the camera device itself, causing the backgrounds in the first and the second images offset with each other. Accordingly, effective methods should be taken to compensate for the physical movement of the camera device prior to identifying the moving parts in the first and second images. For example, the second image may be transformed to compensate for the unwanted physical movement based on the position data provided by a positioning sensor (i.e, gyroscope) integrated in the camera device. That is, he purpose of the transformation of the second image is to align the background in the second image with that in the first image.

It is important to mention that the one or more ROIs are less than an entirety of the first image or the second image, such that when the one or more ROIs are inputted into a first deep neural network (DNN) model (to be discussed below), the computational cost of the first DNN model is significantly reduced from the data source to be processed.

Further, the one or more ROIs are transformed into grayscale. That is, the one or more ROIs are grey processed to transform into grayscale format. Those who skilled in the art would understand that normal images are colorful images such as in RGB format or YUV format to fully represent the features (including illumination and color features) of the imaged object. However, the color feature doesn't do much help in classifying the candidate objects contained in the ROIs, or even unnecessary in some applications. The purpose of gray processing the ROIs is to filter the color information in the ROIs so as to not only reduce the computational cost of the DNN model but also to effectively prevent the color information adversely affecting object detection accuracy.

In order to further minimize the computational cost of the first DNN model, the one or more ROIs may be scaled to particular sizes, i.e 128*128 pixels. In practice, the size reduction of ROIs depends on the accuracy requirement of the people detection and the model architecture of the first DNN model. In other words, the scaled size of the ROIs can be adjusted corresponding to the complexity of the first DNN model and the accuracy requirements of people detection, which is not a limitation in this disclosure.

Further, the one or more grayscale ROIs are inputted into the first DNN model and processed to classify the objects contained in the one or more ROIs and to determine whether the objects contained in the one or more regions include human being.

More specifically, the first DNN model in this disclosure is constructed based on the depthwise separable convolution layers, wherein the depthwise separable convolution layer uses depthwise separable convolution in place of standard convolution to solve the problems of low computational efficiency and large parameter size. The depthwise separable convolution is a form of factorized convolution which factorize a standard convolution into a depthwise convolution and a 1×1 convolution called a pointwise convolution, wherein the depthwise convolution applies a single filter to each input channel and the pointwise convolution is used to create a linear combination the output of the depthwise convolution to obtain updated feature maps. In other words, each depthwise separable convolution layer comprises a depthwise convolution layer for applying a single filter to each input channel and a pointwise layer for linearly combining the outputs of the depthwise convolution layer to obtain a feature map.

The first DNN model comprises N depthwise separable convolution layers, wherein the N is a positive integer and ranged from 4-12. In practice, the number of the depthwise separable convolution layers is determined by the requirements for latency and accuracy in specific scenarios. In particular, the first DNN model may comprises five depthwise separable convolution layers (listed as first, second, third, fourth and fifth depthwise separable convolution layers), wherein the grayscale ROIs are inputted into the first depthwise separable convolution layer.

More detailedly, the first depthwise separable convolution layer comprises 32 filters of size 3×3 in the depthwise convolution layer and filters of size 1×1 in a corresponding number in the pointwise convolution layer. The second depthwise separable convolution layer connected to the first depthwise separable convolution layer comprises 64 filters of size 3×3 in the depthwise convolution layer and filters of size 1×1 in a corresponding number in the pointwise convolution layer. The third depthwise separable convolution layer connected to the second depthwise separable convolution layer comprises 128 filters of size 3×3 in the depthwise convolution layer and filters of size 1×1 in a corresponding number in the pointwise convolution layer. The fourth depthwise separable convolution layer connected to the third depthwise separable convolution layer comprises 256 filters of size 3×3 in the depthwise convolution layer and filters of size 1×1 in a corresponding number in the pointwise convolution layer. The five depthwise separable convolution layer connected to the fourth depthwise separable convolution layer comprises 256 filters of size 3×3 in the depthwise convolution layer and filters of size 1×1 in a corresponding number in the pointwise convolution layer

After obtaining the feature maps from the grayscale ROIs by a predetermined number of depthwise separable convolution layers, the candidate objects contained in the grayscale ROIs are further classified by the first DNN model and a classification result based on a determination of whether the objects contained in the ROIs includes human being. In particular, the deed of classifying the candidate objects contained in the grayscale ROIs is accomplished by a Softmax layer of the first DNN model.

In summary, the process of determining, by the door lock controller 16 processing the image data with a first DNN model, whether the objects contained in the image data includes human is illustrated.

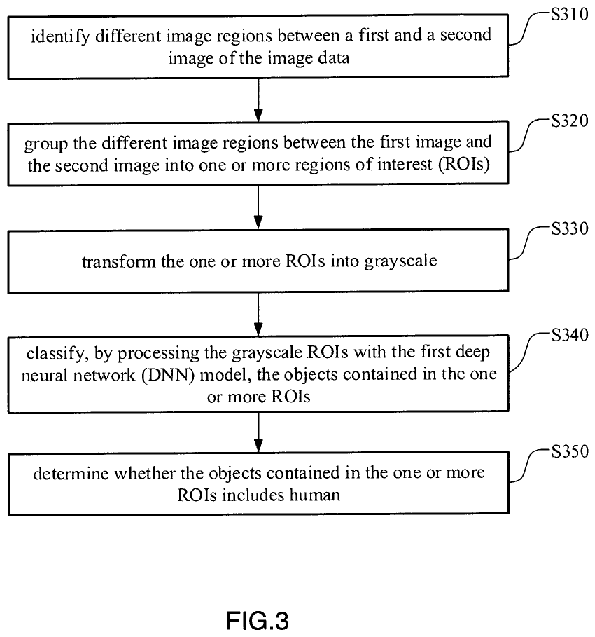

FIG. 3 is a flow diagram illustrating the process of determining whether the objects contained in the image data includes human by a door lock controller 16 processing the image data of the moving object with a first deep neural network model. As illustrated in FIG. 3, this process comprises the steps of: S310, identifying different image regions between a first and a second image of the image data; S320, grouping the different image regions between the first image and the second image into one or more regions of interest (ROIs); S330, transforming the one or more ROIs into grayscale; S340, classifying, by processing the grayscale ROIs with the first deep neural network model, the objects contained in the one or more ROIs; and S350, determining whether the objects contained in the one or more ROIs includes human.

As method above, the one or more criteria further include that the image data containing human face regions. In this disclosure, the specific algorithm adopted for processing the image data for face detection is also based on artificial intelligence.

More specifically, the door lock controller 16 could utilize the spirit of the motion-based object detection method as disclosed in application U.S. Ser. No. 16/078,253 to process the image data to determine whether the image data contains human face regions.

To begin with, the image data is processed using the aforementioned motion-based ROI extraction method to extract one or more ROIs from the image data. Then, the one or more ROIs are transformed into grayscale in order to reduce the computational costs of a second DNN model (to be discussed below). Since the process of ROI extraction and grayscaling are consistent with that of the aforementioned people detection process, detailed description are omitted in this disclosure for purpose of clarity. Further, the one or more grayscale ROIs are inputted into the second DNN model and processed to determine whether the image data contains human face regions.

In this disclosure, the second DNN model may have a same model architecture with the first DNN model, that is, the second DNN model may also be constructed based on the depthwise separable convolution layers. In other words, the first DNN model and the second DNN model in this disclosure can be constructed with a same model architecture but with different model parameters, such that the model compression techniques can be utilized when storing the first and second DNN model in the storage device of the door lock controller 16.

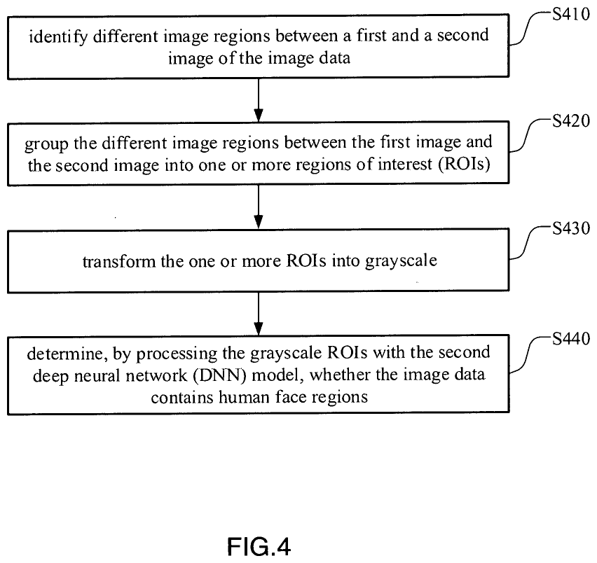

FIG. 4 is a flow diagram illustrating the process of determining whether the image data contains human face regions, by the door lock controller 16 processing the image data of the moving object with a second deep neural network model. As illustrated in FIG. 4, this process comprises the steps of: S410 identifying different image regions between a first and a second image of the image data; S420, grouping the different image regions between the first image and the second image into one or more regions of interest (ROIs); S430, transforming the one or more ROIs into grayscale; and, S440, determining, by processing the grayscale ROIs with the second deep neural network model, whether the image data contains human face regions.

It is appreciated that the people detection and face detection are performed with artificial intelligence algorithm using specific deep neural network (DNN) models which are able to achieve a good trade-off between computational cost and detection precision. Further, the DNN models adopted in this disclosure has a relatively smaller model size that can be employed in the door lock controller 16 for processing the image data of the moving object to determine that one or more criteria are satisfied so as to facilitate the application of DNN models in terminal products.

In summary, this disclosure provides a smart door lock system 10 configured to control the opening and closing of a door of a property's premise. Accordingly, the door lock system 10 comprises an electronically-controlled door lock 12 and a camera system 18 integrated in the electronically-controlled door lock 12, wherein the camera system 18 is configured to capture image data (e.g., video data, still image data, or other type of image data) of the moving object in the area proximate to the door in the field of view thereof. The image data of the moving object captured by the camera system 18 is outputted, in response to determining that one or more criteria are satisfied, for transmission to a remote computing device 20. The owner of the property's premise can review the received image data of the moving object to determine whether to provide a unlock control command to unlock the locking mechanism of the door of the property's premise. In this way, the smart door lock system 10 provides an unlock authority to a computing device 20 which is remote from the door, thereby allowing the owner to remotely unlock the electronically-controlled door lock 12 via the computing device 20 rather than being physically present to perform the security check of the electronically-controlled door lock 12 to open the door. Moreover, automatic transmission of the image data of the moving object, in response to determining that one or more criteria are satisfied, facilitates door surveillance through the integrated camera system 18 to help ensure personal and property's safety.

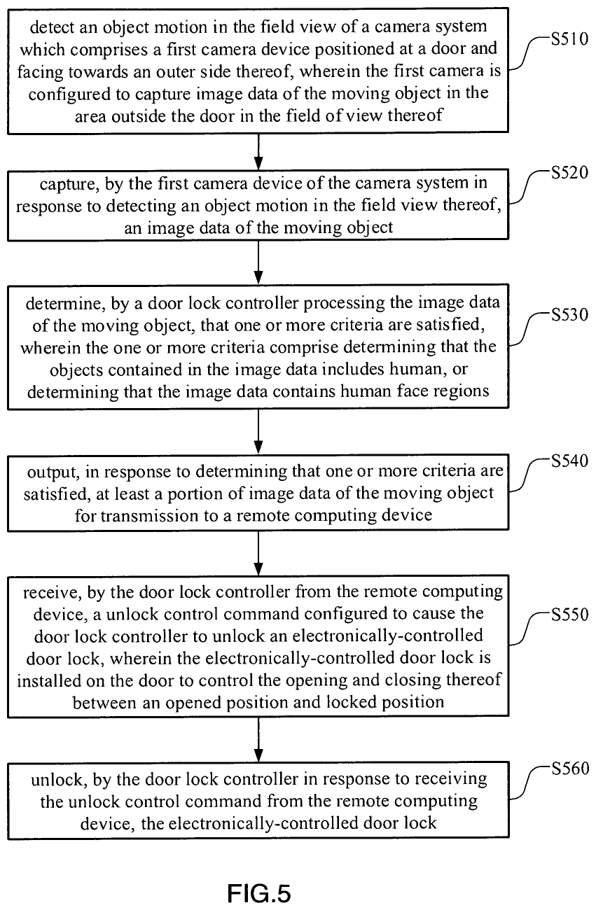

FIG. 5 is a flow diagram of a smart door lock control method according to the above preferred embodiment of the present invention.

As shown in the FIG. 5, the smart door lock control method comprises the following steps.

S510, Detect an object motion in the field view of a camera system which comprises a first camera device positioned at a door and facing towards an outer side thereof, wherein the first camera is configured to capture image data of the moving object in the area outside the door in the field of view thereof.

S520, Capture, by the first camera device of the camera system in response to detecting an object motion in the field view thereof, an image data of the moving object.

S530, Determine, by a door lock controller processing the image data of the moving object, that one or more criteria are satisfied, wherein the one or more criteria comprise determining that the objects contained in the image data includes human, or determining that the image data contains human face regions.

S540, Output, in response to determining that one or more criteria are satisfied, at least a portion of image data of the moving object for transmission to a remote computing device.

S550, Receive, by the door lock controller from the remote computing device, a unlock control command configured to cause the door lock controller to unlock an electronically-controlled door lock, wherein the electronically-controlled door lock is installed to control the opening and closing thereof between an opened position and locked position. and

S560, Unlock, by the door lock controller in response to receiving the unlock control command from the remote computing device, the electronically-controlled door lock.

In one embodiment of this disclosure, the camera system further comprises a motion detector configured to detect object motion in the field of view of the camera system.

In one embodiment of this disclosure, the camera system further comprises a second camera device opposed to the first camera device and facing towards an outer side thereof, wherein the second camera device is configured to capture image data of the moving object in the area inside the door in the field of view thereof.

In one embodiment of this disclosure, the camera system is integrated in the electronically-controlled door lock.

In one embodiment of this disclosure, the step of determining, by a door lock controller processing the image data of the moving object, that one or more criteria are satisfied, comprises the following steps: determining, by a door lock controller processing the image data of the moving object with a first deep neural network model, whether the objects contained in the image data includes human; determining, by the door lock controller processing the image data of the moving object with a second deep neural network model, that the image data contains human face regions; and determining that one or more criteria are satisfied in response to determining that the objects contained in the image data includes human, or determining that the image data contains human face regions.

In one embodiment of this disclosure, the first deep neural network model and the second deep neural network model have a same model architecture with different model parameters.

In one embodiment of this disclosure, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of this disclosure, the step of determining, by a door lock controller processing the image data of the moving object with a first deep neural network model, whether the objects contained in the image data includes human, comprises the following steps: identifying different image regions between a first and a second image of the image data; grouping the different image regions between the first image and the second image into one or more regions of interest (ROIs); transform the one or more ROIs into grayscale; classifying, by processing the grayscale ROIs with the first deep neural network (DNN) model, the objects contained in the one or more ROIs; determine whether the objects contained in the one or more ROIs includes human.

In one embodiment of this disclosure, the step of determining, by a door lock controller processing the image data of the moving object with a first deep neural network model, whether the objects contained in the image data includes human, comprises the following steps: identifying different image regions between a first and a second image of the image data; grouping the different image regions between the first image and the second image into one or more regions of interest (ROIs); transforming the one or more ROIs into grayscale, and, determining, by processing the grayscale ROIs with the second deep neural network (DNN) model, whether the image data contains human face regions.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A smart door lock control method, comprising the steps of:
detecting an object motion in the field view of a camera system which comprises a first camera device positioned at a door and facing towards an outer side thereof, wherein the first camera is configured to capture image data of the moving object in the area outside the door in the field of view thereof;
capturing, by the first camera device of the camera system in response to detecting an object motion in the field view thereof, an image data of the moving object;
determining, by a door lock controller processing the image data of the moving object, that one or more criteria are satisfied, wherein the one or more criteria comprise determining that the objects contained in the image data includes human, or determining that the image data contains human face regions;
outputting, in response to determining that one or more criteria are satisfied, at least a portion of image data of the moving object for transmission to a remote computing device;
receiving, by the door lock controller from the remote computing device, a unlock control command configured to cause the door lock controller to unlock an electronically-controlled door lock, wherein the electronically-controlled door lock is installed to control the opening and closing thereof between an opened position and locked position; and
unlocking, by the door lock controller in response to receiving the unlock control command from the remote computing device, the electronically-controlled door lock.

2. The smart door lock control method, as recited in claim 1, wherein the camera system further comprises a motion detector configured to detect object motion in the field of view of the camera system.

3. The smart door lock control method, as recited in claim 2, wherein the camera system further comprises a second camera device opposed to the first camera device and facing towards an inner side thereof, wherein the second camera device is configured to capture image data of the moving object in the area inside the door in the field of view thereof.

4. The smart door lock control method, as recited in claim 3, wherein the camera system is integrated in the electronically-controlled door lock.

5. The smart door lock control method, as recited in claim 4, wherein the step of determining, by a door lock controller processing the image data of the moving object, that one or more criteria are satisfied, comprises the steps of:
determining, by a door lock controller processing the image data of the moving object with a first deep neural network model, whether the objects contained in the image data includes human;
determining, by the door lock controller processing the image data of the moving object with a second deep neural network model, whether the image data contains human face regions; and
In response to determining that the objects contained in the image data includes human, or determining that the image data contains human face regions, determining that one or more criteria are satisfied.

6. The smart door lock control method, as recited in claim 5, wherein the first deep neural network model and the second deep neural network model have a same model architecture with different model parameters.

7. The smart door lock control method, as recited in claim 6, wherein the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

8. The smart door lock control method, as recited in claim 7, wherein the step of determining, by a door lock controller processing the image data of the moving object with a first deep neural network model, whether the objects contained in the image data includes human, comprises the steps of:
identifying different image regions between a first and a second image of the image data;
grouping the different image regions between the first image and the second image into one or more regions of interest (ROIs);
transforming the one or more ROIs into grayscale;
classifying, by processing the grayscale ROIs with the first deep neural network model, the objects contained in the one or more ROIs; and
determining whether the objects contained in the one or more ROIs includes human.

9. The smart door lock control method, as recited in claim 7, wherein the step of determining, by a door lock controller processing the image data of the moving object with a first deep neural network model, whether the objects contained in the image data includes human, comprises the steps of:
identifying different image regions between a first and a second image of the image data;
grouping the different image regions between the first image and the second image into one or more regions of interest (ROIs);
transforming the one or more ROIs into grayscale; and
determining, by processing the grayscale ROIs with the second deep neural network model, whether the image data contains human face regions.

10. A smart door lock system for controlling the opening and closing of a door, comprising:
an electronically-controlled door lock;
a camera system, wherein the camera system comprises a motion detector configured to detect object motion in the field of view of the camera system, and a first camera device facing towards an outer side of the door, wherein the first camera is configured to capture image data of the moving object in the area outside the door in the field of view thereof in response to an object motion detected by the motion detector in the field of view of the camera system; and
a door lock controller comprising at least one processor and one or more storage devices, the one or more storage device encoded with instructions that, when executed by the at least one processor, cause the at least one processor to:
determine, by a door lock controller processing the image data of the moving object, that one or more criteria are satisfied, wherein the one or more criteria comprise determining that the objects contained in the image data includes human, or determining that the image data contains human face regions;
output, in response to determining that one or more criteria are satisfied, at least a portion of image data of the moving object for transmission to a remote computing device;
receive, by the door lock controller from the remote computing device, a unlock control command configured to cause the door lock controller to unlock an electronically-controlled door lock, wherein the electronically-controlled door lock is installed to control the opening and closing thereof between an opened position and locked position; and
unlock, by the door lock controller in response to receiving the unlock control command from the remote computing device, the electronically-controlled door lock.

11. The smart door lock system, as recited in claim 10, wherein the camera system further comprises a second camera device opposed to the first camera device and facing towards an inner side thereof, wherein the second camera device is configured to capture image data of the moving object in the area inside the door in the field of view thereof.

12. The smart door lock system, as recited in claim 11, wherein the instructions that, when executed by the at least one processor, cause the door lock controller to:
determine, by a door lock controller processing the image data of the moving object with a first deep neural network model, whether the objects contained in the image data includes human;
determine, by the door lock controller processing the image data of the moving object with a second deep neural network model, that the image data contains human face regions; and
In response to determining that the objects contained in the image data includes human, or determining that the image data contains human face regions, determine that one or more criteria are satisfied.

13. The smart door lock system, as recited in claim 12, wherein the first deep neural network model and the second deep neural network model have a same model architecture with different model parameters.

14. The smart door lock system, as recited in claim 13, wherein the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

15. The smart door lock system, as recited in claim 14, wherein instructions that, when executed by the at least one processor, cause the door lock controller to:
identify different image regions between a first and a second image of the image data;
group the different image regions between the first image and the second image into one or more regions of interest (ROIs);
transform the one or more ROIs into grayscale;
classify, by processing the grayscale ROIs with the first deep neural network model, the objects contained in the one or more ROIs; and
determine whether the objects contained in the one or more ROIs includes human.

16. The smart door lock system, as recited in claim 14, wherein instructions that, when executed by the at least one processor, cause the door lock controller to:
identify different image regions between a first and a second image of the image data;
group the different image regions between the first image and the second image into one or more regions of interest (ROIs);
transform the one or more ROIs into grayscale; and
determine, by processing the grayscale ROIs with the second deep neural network model, whether the image data contains human face regions.
